(19) United States
(12) Patent Application Publication
(10) Pub. No.: US 2015/0106200 A1
(43) Pub. Date: Apr. 16, 2015

(54) ENHANCING A USER'S EXPERIENCE BY PROVIDING RELATED CONTENT

(71) Applicant: David Elmekies, Brooklyn, NY (US)

(72) Inventor: David Elmekies, Brooklyn, NY (US)

(21) Appl. No.: 14/514,685

(22) Filed: Oct. 15, 2014

Related U.S. Application Data
(60) Provisional application No. 61/890,989, filed on Oct. 15, 2013.

(51) Int. Cl. G06Q 30/02

(52) U.S. Cl. CPC G06Q 30/0255
USPC 705/14.53

(57) ABSTRACT

The present invention is directed to a modified display for a computing device, where a computing device recognizes a marker in a display, communicates with a remote server to return content associated with the recognized marker, and augments the display by inserting the returned content to a preferred position and orientation in the display.

This application claims priority to U.S. Provisional Patent Application No. 61/890,989, filed on Oct. 15, 2013 and now pending.

### BACKGROUND OF THE INVENTION

On-line gaming and shopping are in widespread use. Gaming in particular, can involve a single player or a plurality of players who are commonly experiencing the same event, albeit in potentially differing locations. However, the gaming experiences to date are generally common experiences among players and/or provide for displays which are largely uniform and independent of the user's physical; environment, and do not include the ability to customize displays for each player within a particular game. For example, the display and the user's present field of vision are not ordinarily coupled into a single display in any way.

On line shopping experiences to date are also largely directed to providing potential purchasers with images, videos, and/or text of a particular product, and providing the potential purchasers with an opportunity to purchase the product. To date, there is no relationship between such images, videos, and/or text with mobility. That is, if a potential purchaser is in the presence of a product of interest, the purchaser needs to separately key information into an on-hand device, such as a mobile smart telephone, so as to gather information regarding the device. At least for the purpose of advertising and potentially for the purposes of education and commerce, delivering such information to the potential purchaser during the purchaser's presence by the product of interest is highly beneficial and desirable.

Also, it is common for consumers these days to be with smart phones which have cameras, real time internet access and processing capability. Consequently, the fundamental capability of the smart phone can be used to photograph an object, recognize the object photographed, and replace or enhance the object with supplemental content which can be used to enhance the consumer's shopping experience, such as by showing the product in use or answering questions the consumer may have.

### BRIEF DESCRIPTION OF THE PRESENT INVENTION

The present invention is directed to forming a relationship between a mobile device and a game, a product, or a display, as examples, that allow for advanced content delivery and also allows for personalizing a display for a user.

The present invention is further directed to recognition of a marker in a fixed or moving image being captured by a computing device with a display screen, recognizing the marker, and taking an action to retrieve another image, video, and/or text for display on the computing device.

### BRIEF DESCRIPTION OF THE FIGURES

FIG. 1 depicts a schematic diagram of the core elements of the present invention.

FIG. 2 depicts a flow chart of key steps in one example of the present invention.

FIG. 3 depicts a flow chart of key steps in a second example of the present invention.

FIG. 4 depicts a flow chart of key steps in a third example of the present invention.

### DETAILED DESCRIPTION OF THE PRESENT INVENTION

The present invention is directed to use of a recognizable marker in physical objects, where the marker is used to indicate a select portion of the object or the entirety of the object.

The marker of the present invention may take a number of forms as detailed below. In one embodiment of the present invention, the marker is an embedded recognizable image, such as a barcode or a QR marker. In another embodiment, the marker may simply be the appearance of an object in the display and the marker may serve as a recognizable object. That is, the system of the present invention may include the ability to recognize borders or content of an object in the field of vision, and such recognition may be used to fully note the present and/or orientation of the object, even as the object moves in the field of vision. Such recognition may be by way of borders, colors, size, or some combination, or a combination of a plurality of such objects. For example, an object may be recognized by its shape in combination with a logo on its face. Together, the shapes of the object and logo, together with their color patterns, may be used to recognize that an object is, say, a particular cereal box.

In this embodiment, recognition software may be embedded in the computing device where the image or video is being displayed or, alternatively, recognition software is embedded in a web server in communication with said computing device. Either way, the computing device or a remote server receives information regarding the marker in the form of a query and returns data to the computing device for display.

The present invention leverages the ability for distributed computing and distributed storage by use of the Internet (or a comparable medium) to query and retrieve various still and/or moving images, potentially in combination with text. Fundamentally in the present invention, an image on a display is captured and identified. That image may be of an actual object in the user's field of vision, and may be captured through use of an on-board camera. The image is identified using recognition software which may be resident on the same device capturing the image or may be on a different device. The recognition is based on a “marker” present in the display and may take the form of a barcode, a OR code, an embedded code of another type, or may just be recognition of an object in the display by way of say, contrast with nearby objects.

The mobile computing device initially identifies the presence of the object in the display and formulates a query based on that image. The image, or data representing the image, is included into a query, ultimately directed to a database, where additional corresponding records exist. The corresponding record or records are returned to the mobile computing device for display. In addition to the image being identified, the location of the image within the display, as well as its orientation, and any movement of the image in the display (such as consequential to the user moving the camera) are captured and the returned records are used to populate an overlay image in the display, where the position and location of the overlay are determined by the system of the present invention, so as to create an enhanced viewing experience for the user.

The control of the display may be by way of an app. That is, the computing device in communication with or incorporated with the visual display can include a particular user interface referred to herein as an app. The app further serves the function of developing queries and receiving data for formulating the display, such as by merging various feeds based on the identified marker.

In other embodiments, multiple markers may be identified and used for determining displays.

In at least one embodiment, the query and retrieval medium may be something other than the internet. For example, the query and retrieval could be wired or wireless, and could be in a private network or using proprietary protocols.

In addition, the retrieval could be from something other than a database. As an example, superimposed video may be streaming video, such as from broadcast television or from some other source, such as stored video. To further the example, if an image of a cartoon character appears in the display, the cartoon associated with the character can appear in the display in the position of the cartoon character. In an alternate embodiment, if an image of a cartoon character appears in the display, the cartoon associated with the character can appear in the display entirely surrounding the image of the cartoon character.

In one embodiment of the present invention, the returned display appears directly on the screen. For example, a consumer with a mobile smart telephone may be in a store and, using the camera portion of the mobile smart telephone, snaps a picture of a particular product on a shelf. A marker, such as a barcode is captured in the picture. The aforementioned recognition software recognizes the barcode, a query is sent to a web server, and a video advertisement is delivered to the mobile smart telephone. Such advertisement may include purchase incentives as well.

A consumer's shopping or gaming experience can be enhanced by making the experience individualized to the user. Such individualization can include delivery of additional or alternate information associated with the present activity of interest of a consumer. The present invention is directed to providing a user with content delivered to, for example, a mobile device where the content is related, at least in part, to an activity the user is presently engaged in. This activity might be shopping or gaming. The customization may preferably relate to any or all of that user's preferences or interests, or the user's locale, and may include providing an enhanced experience such as an augmented reality display.

In another embodiment of the present invention, a display appears directly on the screen. For example, a consumer with a mobile smart telephone may be in a store and, using the camera portion of the mobile smart telephone, begins capturing video of a particular product on a shelf. The aforementioned recognition software recognizes something about the product, such as an image on a box, and may also recognize the box itself, a query is sent to a web server, and a video advertisement is delivered to the mobile smart telephone for placement in the display in the position of the recognized image, an alternative image, or a location related to the image or box. Such advertisement may include purchase incentives as well.

In another embodiment, the delivered video may be in an augmented reality form.

Fundamentally, the present invention provides an enhanced experience to a user. In the method of the present invention, products or their packaging are encoding with a mobile-device readable marker. The user identifies the marker on or associated with a product or activity of interest. The marker typically may be on or near a product, its packaging, or a display (including a video display or audio display). The marker may be in any of several different forms, such as but not limited to a barcode or a QR code. The user photographs, scans, records, or otherwise captures the marker on a computing device. The location of the captured marker in the display is recognized. The captured marker, called the “scanned image” herein, is delivered to a server or database, potentially in combination with other data in the form of a query. Alternatively, the captured marker may be converted to digital data and are delivered to the server or database, preferably in the form of a query, to return data representing display content, such as a video, so as to enhance a consumer's experience. The applicable content may initially be resident in a remote server or may be in a database of such content on the computing device or remote server. The query indicates the marker and, potentially, attributes of the user, such as preferences or locale. Those attributes may later be used for further customization.

The delivered content may be in the form of still images or moving video. The still images may change based on changing position of an identifying marker or encoding. Audio may be provided in combination with still images or moving video. The moving video may take the form of an augmented reality display. A user can direct the positioning, orientation, or other aspects of the appearance of the superimposed feed based on, for example, entering keystroke or audio commands.

In a simple example of the method of the present invention, a user scans a marker on a product using a mobile device. Data regarding the marker is captured on the device. The device then launches a query to a cloud-based server, where the query includes the marker (or an indicator of the marker). The server does a database look up relative to that marker. A response is returned which includes playable content related to that marker. Because of today's high speed databases the query and response can be delivered quickly enough so that the user can receive and play the content while still in the presence of the physical marker, thereby enhancing an experience associated with the product. Also, the present invention presents a database, potentially operating as a distributed database, in which entries exist which can be associated with data of the markers. There may be large numbers of entries in the database, with each entry having one or more related entries. These related entries can include content data or instructional data, and the related data can be returned to a querying device for use by the device.

In one example, a user may snap a picture of an environment, such as a block of houses. One house may be identified through use of a marker. The display, inclusive of that house can be augmented, such as by placing a picture of the user at the front door of the identified house.

The present invention is particularly applicable to at least three different types of uses, including those involving (1) shopping scenarios such as but not limited to in-store point of sale or other purchase scenarios, (2) video-based or audio-based advertising, such as on television or radio, and (3) gaming, including online gaming with remote game players. Each is discussed separately below. Any data delivered to the server, including but not limited to data regarding date/time, locale of the request, and user demographics can also be stored, such as in a cloud-based database, for later analysis and use.

All three scenarios involve some similar functionality. In each, a user identifies a marker and, ordinarily, uses a computing device which contains a camera or other element with the ability to photograph, scan, record, or another capture function, to electronically capture the marker to the device. The device may be, by way of example, a mobile phone, tablet computer, or a computer. The device may have an application (as “app”), which would be a part of the present invention, loaded on it which serves as a front end whereby a scanned image is recognized and/or uploadable. In lieu of an app, the computing device may use a web portal or some equivalent to provide the aforementioned capture and delivery functions as well as to provide communication access to the Internet. The marker may be combinations of images or sounds. The marker might be, for example, a QR code on a package, a bar code on a package, a scannable image on a shelf, a label, an image in an advertisement within a video, a human face, sequenced sounds, or some other scannable image. The image may be a customized image as well, such as an enhancement to a QR code, or may be a combination of multiple images. Portions or all of the marker may be encoded for later use.

The present invention introduces a database of data representing specialized markers with companion related data. Such related data may actually be multiple sets of data with, for example, each data set representing different video or different backgrounds. Data can also be instructional data, such as control data directing the device to, for example, display different content based on the device's orientation and movement.

In one embodiment, a QR marker resides inside an AR (Augmented Reality) marker. In another embodiment, another element is added to an AR marker, such as a QR code in the middle, which increases the number of possible marker variations, because it adds another variable graphic element to the AR code; in turn, this increases the number of different AR experiences possible for one software build to trigger.

In another embodiment, a scannable graphic, such as a QR marker, functions as a link that takes the customer to a page where they can download an app, which allows them to trigger an AR experience. Once the app is downloaded, the customer could scan the same graphic using the app, but this time an AR experience would be triggered. The code could also function as a kind of one-stop shop where customers could automatically download a demo app and then, immediately thereafter, experience the technology built into the product using the same code.

In the preferred method of the present invention, a user scans an image of interest (inclusive of the marker) and image recognition software on the device is used to recognize and, as needed, decode the image. In another embodiment, the image recognition software may be elsewhere, such as on a web server. The scanned image is operated on in either of two ways—it may be encoded in some way before being included in a query directed to a pre-designated destination server, which preferably is cloud-based. A database may be associated with the server. Data reside in the server (or database) and are associated with each marker. In this approach, the pre-designated destination server receives data related to the marker and returns information to the device related to the marker. Alternatively, the marker data are compared with data in an on-board database, where the data in the database represent numerous markers.

Additional data may also be delivered as a part of the query to the destination server, such as data indicative of the locale of the device (such as, for example, an IP address), and/or indicative of the user of the device. For example, the mobile device may store data representative of previously identified products of interest to that particular user, and additional videos regarding those products and can be delivered to the user. Similarly, based on locale data, the user may receive shopping aids, such as coupons, usable during the consumer's store visit.

As noted, in the methods of the present invention, the mobile device sends data to a remote server or database and receives corresponding response data. The nature of the response data may vary based on numerous factors, but could include one or more among images, videos, or text, potentially including clickable links.

Using the purchase scenario as an example, a user may scan one or more portions of a product's packaging using a mobile device while shopping. In response, a video might be delivered to the mobile device showing use of the product or some other data related to the product. Subsequent to delivery and play back of the video, device interaction with the server could continue, such as allowing a point of sale purchase, including traditional functions such as but not limited to credit card authorization. Alternatively, further data may be delivered to the device, such as coupons, further advertising, instructional materials, reviews, and so on.

Alternatively or in addition, the delivered video could include or be used to form an augmented reality display, in which multiple images or videos may be combined into a single image or video so as to give the appearance of, for example, that particular user using that particular product or giving a three dimensional effect. The device may be used as a part of an Augmented Reality presentation. Examples include a combination of multiple images or videos, such as showing the product in use by the holder of the device, or showing a product in combination with something related to the user's locale, or potentially something about the user or other similarly situated users. As such, images or videos may need to be edited into single displays. To do so, the device needs to concurrently display portions of multiple images, where the user perceives the combined image, potentially including in the form of augmented reality. The display content may include portions of what may be visible to the device's camera, either a still image or video, and have that content merged in some way with delivered content. For example, if the product of interest is a cleaning tool, the delivered content could be video in which the holder of the device is seen using the cleaning tool. Such image/video merger can happen within the app or can happen remotely in the server and then delivered to the device.

With regard to video displays, such as television ads, as an example, a user can use a device as described above to capture an image or a marker on a video screen. The marker may appear in a standalone display (advertisement) or as a part of a television show. The marker again may appear as an image or a sound, or some combination. Such an image could include a QR code, a product package, a sound file, or some other data visible or emanating from a video or audio feed. In the context of the present invention, the camera of the device may also take still or moving images of the user or the facility the user is in. As described above, the captured image is used to send data to a pre-determined distant server, which responds with data used for playback to the user. Such content can include audio, video, text, or images, as examples. Similar to the earlier description, the playback can take a variety of forms, including video formed by interspersing multiple images on each frame. For example, while a user is watching television, the user can scan a marker either by proactively turning on an app or other utility or automatically that appears on the screen or by sound, and the scanned marker could be delivered in a query for retrieval of additional content. That additional content could be delivered to the computing device and the user can have enhanced material to be viewed concurrently with the material on television.

Similarly, the same scenario can apply to movies. In addition, the method of the present invention may be further enhanced by including the ability for point of sale transactions, including payment. Extending the movie example, one could scan a marker on the screen which represents popcorn, the user can pay for the popcorn with the mobile device used for scanning, and the locale information can be used for the theater to deliver the popcorn or allow the user to obtain popcorn, such as at a counter, with limited or no additional interaction with the sales staff.

With regard to the gaming application, as an example, the gaming experience can be enhanced substantially by an augmented reality display, such as by providing an enhanced three dimensional effect, particularly when encompassing backgrounds representing the user or encompassing the user him or herself. This is particularly true with regard to online gaming. For an online gaming application, a user might begin playing the online game through an app, whereby the app becomes the recipient of the online game content as well as additional content, such as additional content related to the user or the locale. The display provided to the user might also be delivered to others, such as other players, in the game as well.

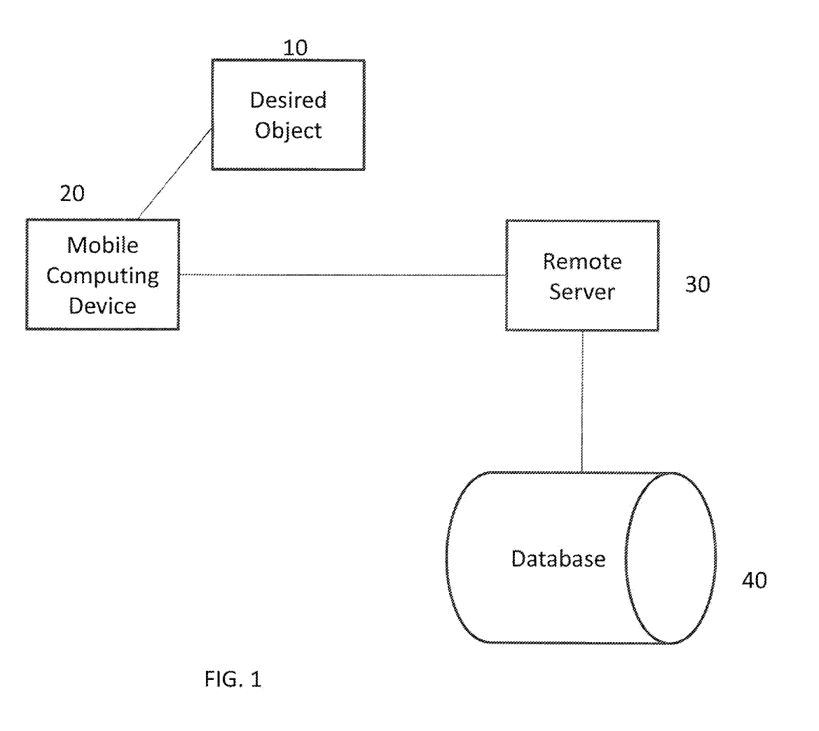

FIG. 1 depicts a block diagram of the core elements of the present invention. Mobile device 20 captures an image, either a still or moving image, of a desired object 10. Mobile computing device 20 may have image recognition software onboard to recognize some or all or some the image being captured, and data of the captured image are relayed to remote server 30. In an alternative embodiment, the image recognition software may be resident at the remote server. Remote server 30 queries database 40 to determine an entry in database 40 related to the identified image. Database 40 returns an entry corresponding to the image, which is interpretable by mobile computing device 20 as a still or moving image and potentially with sound, and the image is forwarded to mobile computing device 20 for populating its display. Also returned by remote server 30 is information regarding orientation of the returned image and where to locate the returned image on the display, particularly as the holder of mobile computing device 20 turns, rotates, reorients, or otherwise moves mobile computing device 20 such that the captured image is moved within the display.

More detailed overview and flows are shown below, particularly related to augmented reality displays.

### Example 1

### A Point of Sale Experience and/or Purchase

In general, the problem being solved is that product information isn't readily available to customer because of lack of salespeople, other available styles aren't displayed, etc.

If something is out of stock, customer has no immediate, seamless way of pre-ordering (again, lack of salespeople).

The customer has no way of looking up more info without an Internet/data connection.

Before, technology only allowed for scanning a barcode-type marker in order to trigger content; now, practically any image can be used—images are less obtrusive and more pleasing to the eye/customer than barcodes.

Before, technology only allowed us to store 40-80 images. Now, because there's a database in the cloud that can be populated (can populate more than one database, each one can hold about a million images), which allows building a more expansive library of markers for a much larger selection of products. Numerous trigger points can be included within each marker as well, where each trigger point can later be used in determining the precise display in, for example, an Augmented Reality display.

No usage data was available to clients in previous manifestation of technology. Now, analytics are built in so that clients can gather data on customers and users.

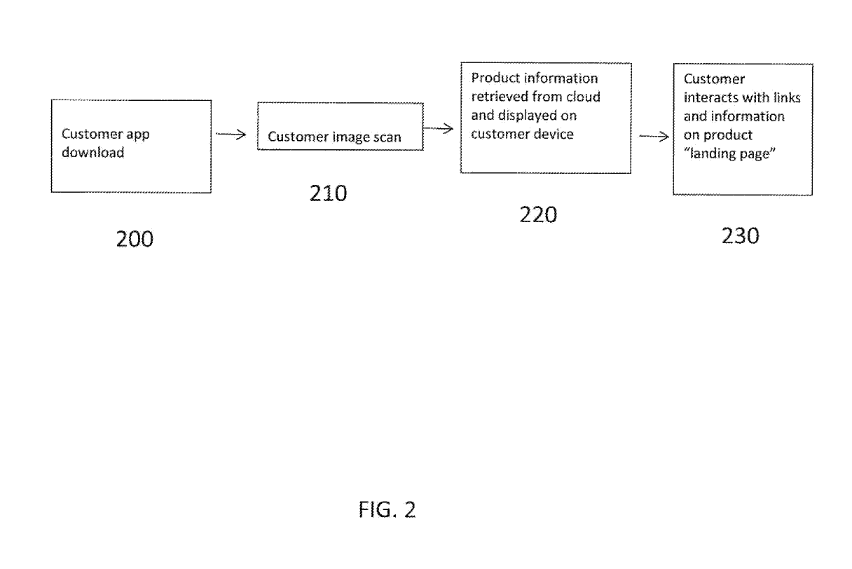

In this example, as depicted in FIG. 2, a user initially downloads an app 200 and then scans an image found somewhere on product/product tag with camera on their mobile device 210. Information is retrieved from cloud and displayed on user's device 220. Content can be anything and allow user to interact further with it 230.

### Example 2

### Television or Movies (Ad and Content)

“Second-screen” phenomenon is taking hold with wide adaptation of mobile smart devices, but people have no way of actually making the two “screens” interact, i.e., using the content on one to trigger content on the other.

Also, there is no way to transition immediately from ad to purchase on TV in real time and no way to transition from product placement in TV shows directly to purchase.

Before, technology only allowed for scanning a barcode-type marker in order to trigger content; now, practically any image can be used, eliminating the need to put an obtrusive barcode onscreen.

Before, technology only allowed us to store 40-80 images. Because in the present invention there's a database “in the cloud” that can be populated (can populate more than one database, each one can hold about a million images), a more expansive library of markers can be retained and used for a much larger selection of products. Numerous trigger points can be included within each marker as well, where each trigger point can later be used in determining the precise display in, for example, an Augmented Reality display. The marker can be visible to the device and invisible to the human eye (so as to not take up visible space).

No usage data was available to clients in previous manifestation of technology. Now, analytics are built in so that clients can gather data on customers and users.

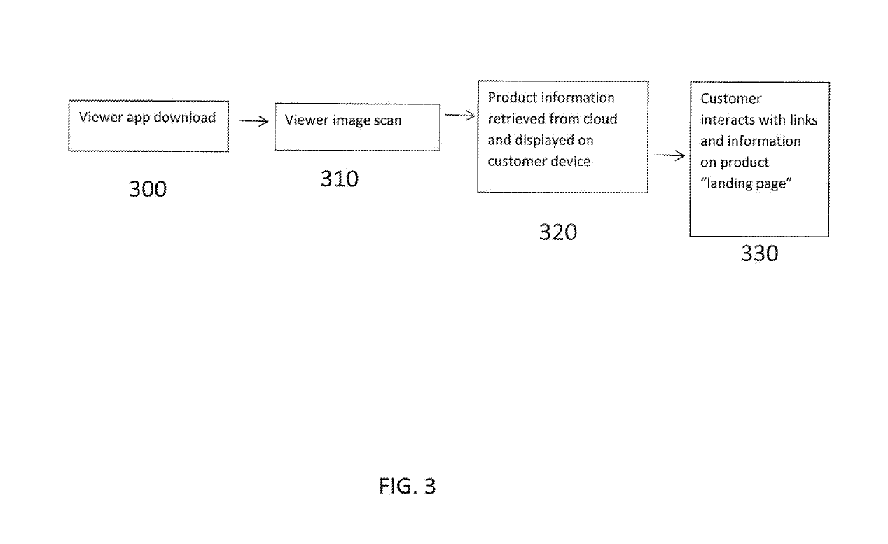

Basically, in this example, as depicted in FIG. 3, a user downloads app 300, scans an image of product or promotion 310, and product/purchase information/interface is displayed on user's device 320, allowing the user to learn more about the product and/or interact 330, such as immediately purchase the item or be taken to a landing page.

### Example 3

### Gaming

Until now, users have had no ability to use the real-world environments they find themselves in as gameplay environments, or to integrate live action with animation in the same display.

Before a scannable image needed to be chosen and programmed on the backend. Now, users can choose a trigger image to trigger content by scanning an image from environment.

Difference in content able to be triggered: Before, we were unable to present augmented reality (AR) into the real world beyond the image marker and couldn't get software to recognize the contours of the real-world environment. In the present invention technology is being implemented to allow a scan of the actual environment so that once a trigger is scanned, we can move past the marker and have the virtual objects interact with the real environment, allowing the user to move a camera away from the marker and continue to watch and listen to the AR experience. The software of the present invention identifies a reference area or object and its location and orientation and then constructs a virtual 3D representation of the real environment, and the virtual objects interact with that.

Before, technology only allowed us to store 40-80 images. Because there's a database “in the cloud” that can be populated (can populate more than one database, each one can hold about a million images), a more expansive library of markers for a much larger selection of products may be built. Numerous trigger points can be included within each marker as well, where each trigger point can later be used in determining the precise display in, for example, an Augmented Reality display. The marker can be visible to the device and invisible to the human eye (so as to not take up visible space).

No usage data was available to clients in previous manifestation of technology. Now, analytics are built in so that clients can gather data on customers and users.

Before, the technology did not allow for multiplayer interactivity. Now, it does, allowing users to play against one another and interact with each other.

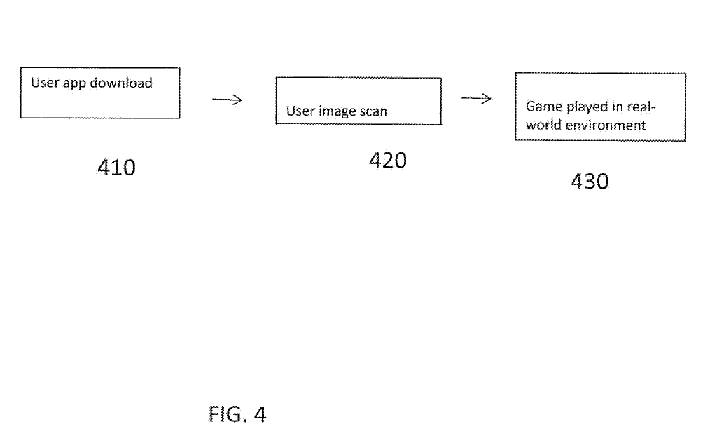

Basic functionality is shown in FIG. 4. A user downloads an app 400 and starts a game. A user scans an image 410. The game is played in real-world environment 420 (e.g. Obstacles appear superimposed in a real-world environment).

The present invention includes the potential to combine two or more video feeds, allowing user to manipulate and interact with animation, etc.

1. A method for a processor-controlled computing device in communication with a video display to customize said video display by concurrently displaying a plurality of video feeds, comprising the steps of:
receiving a first video feed from a camera in communication with said computing device,
identifying an encoding in said first video feed, including identifying said encoding's position and orientation,
said processor tracking movement of said encoding's position and orientation,
said processor querying a database for an entry associated with said encoding, wherein data of said entry represent content for a superimposed feed and instructions for display of said content, and
said processor directing said video display to display said content in accordance with said instructions;
wherein the position and orientation of said superimposed feed are synchronized with any changing position and orientation of said encoding.

2. The method of claim 1 wherein said encoding is recognized as border points of an image.

3. The method of claim 1 wherein said encoding represents an object in the field of vision.

4. The method of claim 1 wherein said superimposed feed appears as an augmented reality display.

5. The method of claim 1 wherein said superimposed feed is a still image.

6. The method of claim 1 wherein said superimposed feed is in the form of video.

7. The method of claim 1, wherein said computing device further includes an audio player and said processor concurrently delivers audio to said audio player and said superimposed image changes at least in part based on said audio.

8. The method of claim 1, wherein said superimposed image changes based on user input, where said input includes at least one of a keystroke, multi-touch, or audio.

9. A system for concurrently displaying a live video feed and a superimposed video feed comprising:
a video camera;
a processor-controlled computer;
a video display;
an encoded object;
a data library with entries including digital content and display instructions for displaying said digital content;
a tracker to track the movement and orientation of an encoding in said encoded object;
wherein said live video camera delivers said live video feed for display on said video display; and
wherein said processor identifies an encoding in said encoded object, identifies an entry in said data library corresponding to said encoding, superimposes a video feed in at least in the position of said encoding, and synchronizes the superimposed video feed to any changing position and orientation of said encoding.

10. The system of claim 9 wherein said encoding is recognized as border points of an image.

11. The system of claim 9 wherein said encoding represents an object in the field of vision.

12. The system of claim 9 wherein said superimposed feed appears as an augmented reality display.

13. The system of claim 9 wherein said superimposed feed is a still image.

14. The system of claim 9 wherein said superimposed feed is in the form of video.

15. The system of claim 9 wherein said computing device further includes an audio player and said processor concurrently delivers audio to said audio player and said superimposed image changes at least in part based on said audio.

16. The system of claim 15 wherein said audio is selected by said processor based on at least one of a microphone input or audio playback from said computer or an external sound delivery device.

17. The system of claim 9 wherein said superimposed image changes based on user input, where said input includes at least one of a keystroke, multi-touch, or audio.

18. A method for a processor based computing device to form a merged image on a video display comprising the steps of:
receiving a first video feed from a camera associated with a computing device, where said first video feed;
recognizing an image and its position and orientation in said first video feed;
querying a database and receiving in response data content and instructions for display of said data content; and
delivering a merged video feed inclusive of representation of said content to said display which includes an augmented reality effect relative to the position of said image;
wherein said merged video feed is adjusted based on the position and orientation of said image.

19. The method of claim 18 wherein said image is recognized based upon recognizing at least some of its border points.

20. The method of claim 18 wherein said superimposed content is included in the form of video.
